(19) United States
(12) Patent Application Publication
(10) Pub. No.: US 2008/0266402 A1
(43) Pub. Date: Oct. 30, 2008

(54) METHOD AND DEVICES FOR LINKING AUDIOVISUAL CAPTURE DEVICE

(76) Inventors: Jen-Chih Wu, Taoyuan (TW); Sheng-Fu Cheng, Taipei (TW); Jung-Jen Lee, Banciao City (TW); Nai-Wen Huang, Bade City (TW); Shih-Wu Fan-Jiang, Pingjhen City (TW); Yen-Chun Liao, Taichung City (TW)

Correspondence Address: RABIN & BERDO, P.C., Suite 500, 1101 14 Street, N.W., Washington, DC, 20005, US

(21) Appl. No.: 11/954,003

(22) Filed: Dec. 11, 2007

(30) Foreign Application Priority Data
Apr. 30, 2007 (TW) 096115235

(51) Int. Cl. H04N 5/225

(52) U.S. Cl. 348/207.1; 348/E05.024

(57) ABSTRACT

A method and devices for linking an audiovisual capture device, which enable an operator to use a terminal device at his end to locate an audiovisual capture device installed at another end through a network architecture, thereby facilitating the Implementation of the subsequent installation and setting operations. The method includes: execution of a first processing procedure by the audiovisual capture device, and execution of a second processing procedure by the terminal device. After the two processing procedures have been completed, the information linking is effected between the terminal device and the audiovisual capture device, which enables the operator to use the terminal device to execute installation and setting up of the audiovisual capture device.

### BACKGROUND OF THE INVENTION

(a) Field of the Invention

The present invention relates to a method and device for linking an audiovisual capture device, and more particularly to a method and device of a terminal device and an audiovisual capture device which respectively produce internet protocol addresses to effect the linking of networks of computer information, thereby enabling the terminal device at another end to locate the audiovisual capture device in a network architecture.

(b) Description of the Prior Art

audiovisual capture devices having network functionality are becoming increasingly common in the current application market, and they include devices such as network cameras, network audiovisual servers, network audiovisual storage equipment, and the like. Moreover, due to the substantial improvement in network infrastructure, use of the network camera is becoming more and more widespread, especially in the field of surveillance where the network camera is gradually replacing the traditional CCTV camera.

However, the first step for the user to use a network camera is installing the network camera itself. Generally, installation and setting up of a network camera is carried out by using a personal computer (PC). Accordingly, the PC must first be able to find the camera in the network architecture and establish an information link with the network camera, and only then it can be subsequently installed and the setting up can be carried out. During the process of initializing settings in the prior art, the initial Internet Protocol Address (hereafter referred to as “IP address”) of the network camera often does not belong to the same network domain as the IP address of the PC, resulting in the PC being unable to locate the network camera, and thus preventing subsequent installation and setting up from being carried out. Hence, during the process of initializing settings in the prior art, the user almost always need to manually set up an IP address for the PC.

In the prior art, there are three methods for the network camera to acquire an initial IP address:

(1) The network camera itself is preset with a set of default virtual fixed IP addresses;

(2) The network camera uses a sharing device to acquire a set of non-fixed IP addresses by means of Dynamic Host Configuration Protocol (DHCP) technology;

(3) Under a dial-up network environment, a set of fixed or non-fixed IP addresses are acquired from an ISP (Internet Service Provider) by means of Point-to-Point Protocol over Ethernet (PPPoE) technology.

Some network cameras of prior art also combine the aforementioned three methods to acquire two sets of the above initializing IP addresses.

The network camera preset with a set of default virtual fixed IP addresses of the first method usually results in a situation whereby the initial IP address of the network camera often belongs to a different network domain to that of the IP address of the PC. The same situation also arises when DHCP technology of the aforementioned second method of prior art is used to acquire an initial IP address. In addition, if a network camera wants to acquire an IP address using the second method, then the sharing device must be provided with functionality to support DHCP; and should the sharing device not support DHCP functionality, then the network camera is unable to acquire an IP address. Likewise, the third method similarly produces a situation whereby an IP address of the network camera acquired through an ISP belongs to a different network domain to that of the IP address of the of the user.

Regardless of what of the aforementioned methods is used, once the initial IP address of the network camera does not belong to the same network domain as that of the IP address of the PC, then the user have to manually set up an IP address for the PC in order to establish the information linking between the network device and the PC. Generally, it takes following steps to set up the IP address manually:

(1) The user has to assign an IP address and a subnet mask for the PC in order that the IP address of the PC belongs to the same network domain as the IP address of the network camera;

(2) For the user to execute step 1, the user first has to know the initial IP address of the network camera. In the prior art, different manufactures preset the network cameras with different virtual fixed IP addresses, the most common setting being: 192.168.m.n, wherein m, n are integers lying between 0 and 255. If the network camera has been set up before, the user has to find out which IP address is previously assigned to that network camera. If the user is unable to find out that, he has to restore the network camera to the default settings of the manufacturer and try to find out what the default setting is.

(3) After the user knows the current IP address of the network camera, the user needs to set up the IP address of the PC accordingly, so that the IP addresses of the PC and the network camera belong to the same network domain. In order to carry out this step, the user needs to have a substantial understanding of network configuration settings, including IP addresses, subnet masks, default gateways, and so on.

From the aforementioned it can be known that the prior art has at least the following shortcomings:

(1) Because of the increasing complexity of network architectures, when installing a network camera, it is extremely easy to create a situation where the PC and the network camera are located in different network domains, thereby resulting in the PC being unable to locate the network camera;

(2) Although the network camera is gradually becoming an electronic device of common use in daily life, however the ordinary consumer probably does not have the ability and skill to set up the network camera. Since the prior art requires the user to manually set up the network addresses and the whole process is so complex, only the user with sufficient background knowledge can finish the set up process without any hitch. And this is not only extremely inconvenient for the ordinary user, but also a serious hindrance.

### SUMMARY OF THE INVENTION

In light of the aforementioned problems, a primary objective of the present invention is to provide a method and devices for linking an audiovisual capture device, comprising an audiovisual capture device and a terminal device individually provided with an IP address to ensure mutual information linking between the audiovisual capture device and the terminal device under an initial state. Moreover, the present invention allows a user to use the terminal device at his end to quickly complete installation and setting up of the audiovisual capture device at another end.

In order to achieve the aforementioned and other objectives, the present invention proposes a method for linking the audiovisual capture device, wherein when the audiovisual capture device executes initialization, the method executes the following steps: First, the audiovisual capture device executes a first processing procedure to enable adding a first target address to the audiovisual capture device; next, the terminal device executes a second processing procedure to enable adding a second target address to the terminal device. Because the first target address and the second target address are predetermined to belong to the same network domain, thus, the first target address and the second target address can be used to ensure the terminal device is able to locate the audiovisual capture device and realize mutual information linking.

In order to achieve the aforementioned and other objectives, the present invention proposes an audiovisual capture device which automatically produces a first target address when activated, comprising a main program, which is used to execute initialization operations; an address producing unit, which is used to produce at least one first target address; an address search unit, which is used to search a network for the address of at least one hardware device; a broadcasting unit, which is used to broadcast at least one probing packet; an arbiter unit, which is used to differentiate the reply results of the probing packets; an address allocation unit, which is used to allocate the first target address after confirmation; and an announcement unit, which is used to announce the first target address after confirmation.

To enable further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a schematic view depicting a connecting structure of the installation according to the present invention.

FIG. 2 shows a schematic flowchart of an embodiment according to the present invention.

FIG. 3 shows a schematic flowchart of an embodiment of a first processing procedure according to the present invention.

FIG. 4 shows a schematic flowchart of an embodiment of a second processing procedure according to the present invention.

FIG. 5 shows a schematic view depicting program elements required by the embodiment of the present invention.

### DETAILED DESCRIPTION OF THE PREFERRED EMBODIMENTS

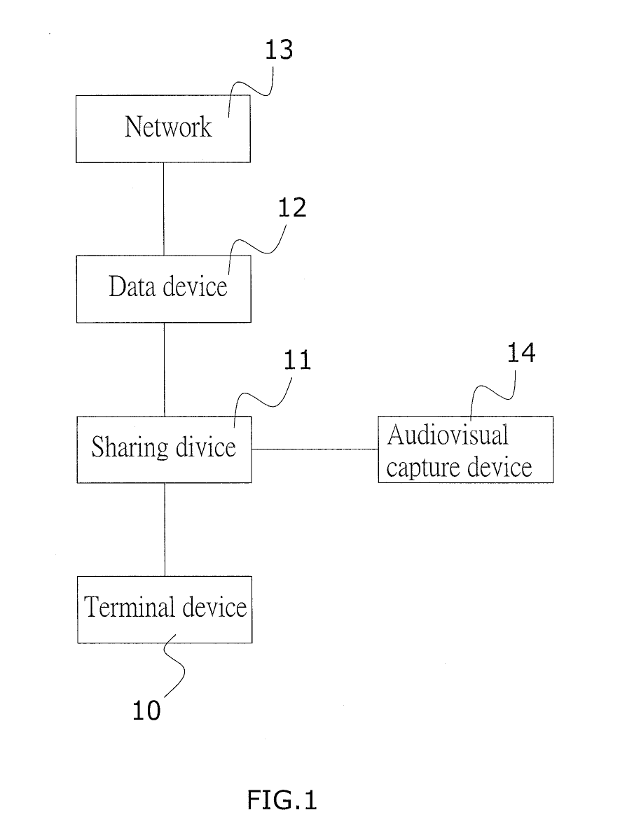

Referring to FIG. 1, which shows a schematic view depicting a connecting structure of the installation, wherein a terminal device 10 is connected to a sharing device 11, the sharing device 11 is connected to a data device 12, and the data device 12 is connected to a network 13. Moreover, an audiovisual capture device 14 is further connected to the sharing device 11. According to the above, the aforementioned terminal device 10 can be a computer, a notebook computer, a PDA and similar electronic devices provided with communication functionality and ability to enable operations to be carried out and settings to be made thereon. The aforementioned sharing device 11 is either a hub provided with a plurality of connecting ports, a switch or an IP router. The aforementioned data device 12 is an ADSL modem or a cable modem. The aforementioned audiovisual capture device 14 is a network electronic device, such as a network camera, a network video storage equipment or a network video server, able to capture and transmit static and dynamic images or sound; and in the embodiment of the present invention, the audiovisual capture device 14 is a network camera, which has network capability, and which is provided with functionality to capture either image or sound or both.

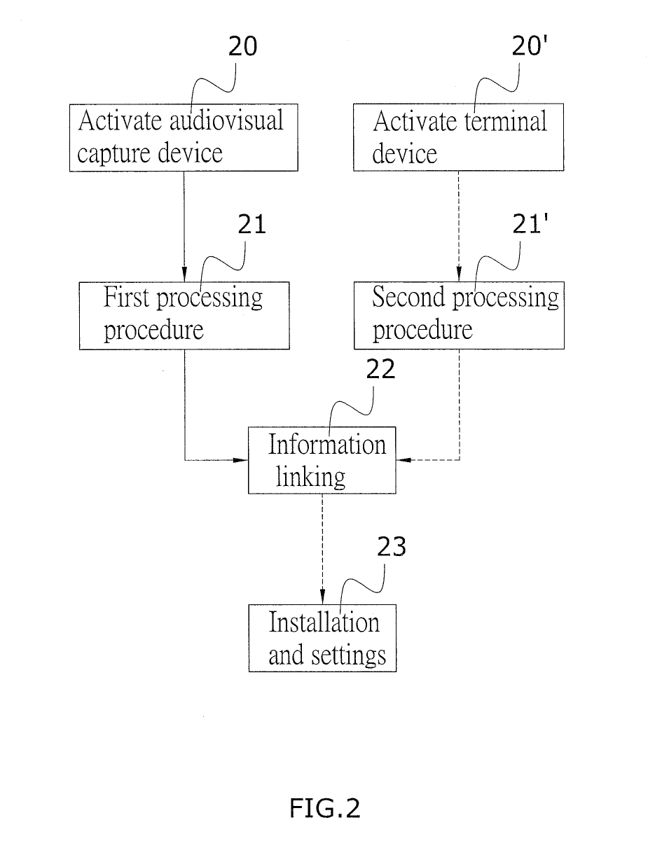

Referring to FIG. 2, which shows a schematic flow chart of an embodiment according to the present invention, wherein after completing physical connection of the audiovisual capture device 14 and the terminal device 10 through the sharing device 11 (as depicted in FIG. 1), then the method of the present invention can be accordingly implemented, steps of which are as follows:

Step 20: Activating the audiovisual capture device 14;

Step 21: Implementing a first processing procedure by a firmware program built into the audiovisual capture device 14;

Step 20′: Activating the terminal device 10;

Step 21′: Executing an application program by the terminal device 10, implementing a second processing procedure;

Step 22: Completing mutual information linking between the audiovisual capture device 14 and the terminal device 10;

Step 23: Implementing installation and setting of the audiovisual capture device 14 by the terminal device 10.

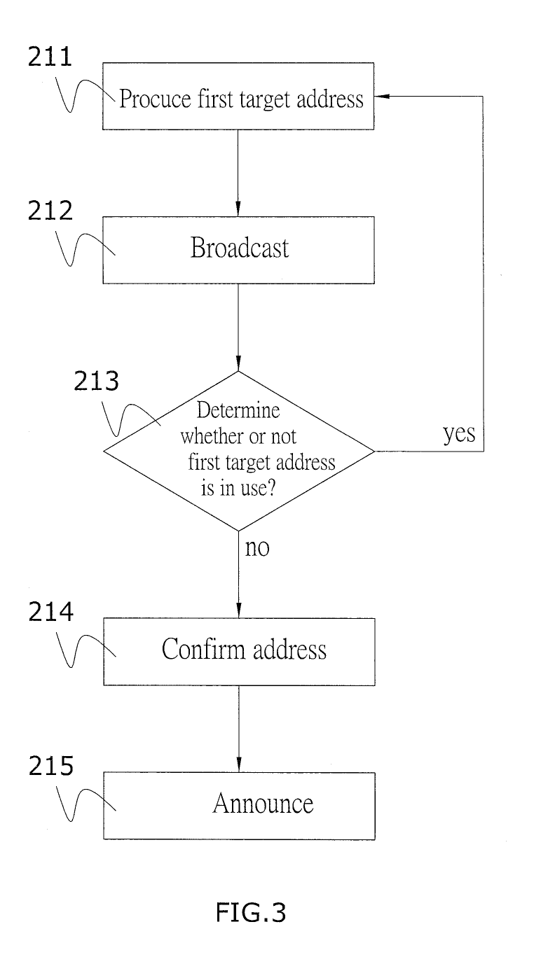

Referring to FIG. 3, which shows a schematic flow chart of an embodiment of step 21 of the first processing procedure (as shown in FIG. 2), wherein when the audiovisual capture device 14 is activated and the firmware program starts executing, then the first processing procedure 21 starts processing, and comprises the following steps:

Step 211: Initializing settings of the audiovisual capture device 14 by the firmware program, and producing a first target address;

Step 212: Implementing broadcasting of the first target address produced;

Step 213: Determining whether or not the already produced first target address is in use by other devices based on response to the broadcasting, and if the first target address is already in use, then the decision result is “yes”, whereupon the firmware program returns to step 211 to produce another first target address. If the first target address is not in use, then the decision result is “no”, and step 214 is implemented;

Step 214: Confirming the already produced first target address is the IP address of the audiovisual capture device;

Step 215: Implementing announcement of the confirmed first target address.

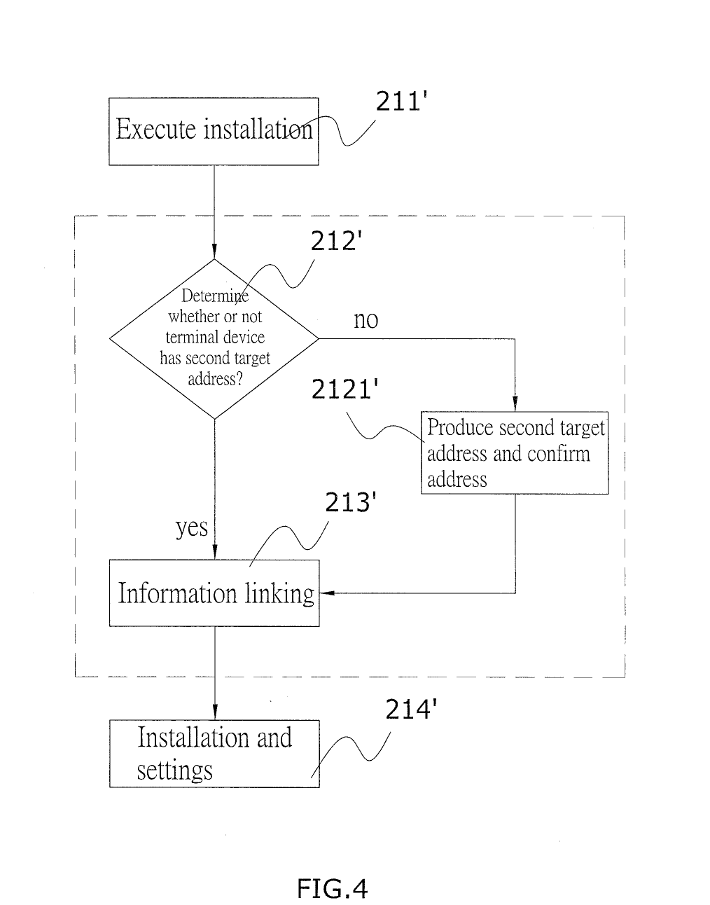

Referring to FIG. 4, which shows a schematic flow chart of an embodiment of step 21′ of the second processing procedure (as shown in FIG. 2), wherein when the terminal device 10 executes the application program, then the second processing process 21′ starts processing, and the application program first carries out instructions to execute installation 211′, after which the following steps are implemented:

Step 212′: Determining whether or not the terminal device 10 is provided with a second target address;

If the terminal device 10 is provided with a second target address, then the decision result is “yes”, a step 213′ is immediately implemented. If the terminal device 10 is not provided with a second target address, then the decision result is “no”, and then step 2121′ is implemented. In step 2121′, the application program automatically causes the terminal device 10 to produce at least one second target address, and, moreover, implements confirmation of the address. Detailed steps involved in confirming address are identical to the steps 212 to 215 disclosed above in describing FIG. 3.

Step 213′: the terminal device 10 uses the second target address to complete information linking with the audiovisual capture device.

Step 214′: After the two have completed information linking, then the terminal device 10 implements the procedure of subsequent installation settings for the audiovisual capture device 14.

Since the first target address and the second target address are virtual IP addresses, their network domains can be preset to be the same. For example: the first target address and the second target address can be corresponding link-local addresses (169.254/16). Accordingly, after completing the prior steps described above, then the audiovisual capture device 14 and the terminal device 10 are able to search for each other, thereby completing information linking, and the user naturally does not need to manually implement setting of IP addresses.

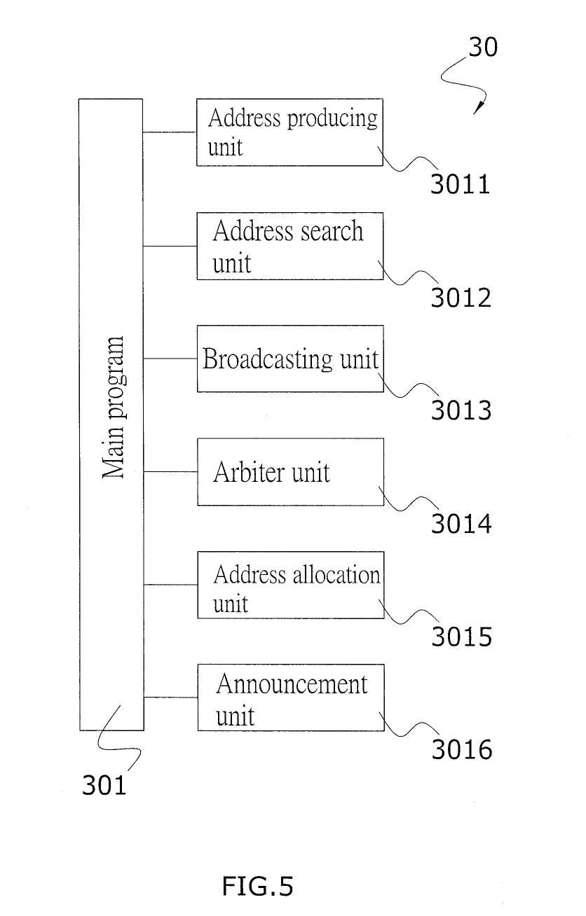

Referring to FIG. 5, which shows a schematic view depicting program elements required by the audiovisual capture device to implement the method disclosed in the present invention. The firmware program 30 of the audiovisual capture device primarily comprises at least a main program 301, which is used to execute initialization operations; an address producing unit 3011, which is used to produce target addresses; an address search unit 3012, which is used to search the addresses of peripheral hardware; a broadcasting unit 3013, which is used to broadcast ARP probing packets; an arbiter unit 3014, which is used to differentiate the reply results of the probing packets; an address allocation unit 3015, which is used to allocate the target address after confirmation; and an announcement unit 3016, which is used to announce the target address after confirmation. According to the above, the firmware program 30 is built into the audiovisual capture device 14.

From the aforementioned it can be known that the method and devices provided by the present invention substantially simplifies the installation procedure of the audiovisual capture device 14, which enables the ordinary user to easily complete installation and setting. Moreover, according to the embodiments as disclosed above, the present invention is clearly able to achieve the objective of providing a method and devices for linking an audiovisual capture device.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A method for linking an audiovisual capture device, comprising following steps:
executing a first processing procedure by said audiovisual capture device to produce a first target address;
executing a second processing procedure by a terminal device to produce a second target address;
wherein said first target address and said second target address belong to same network domain, and said first target address and said second target address are used to enable said audiovisual capture device and said terminal device to complete information linking.

2. The method for linking an audiovisual capture device according to claim 1, wherein said first processing procedure comprises following steps:
producing said first target address;
determining whether or not said first target address is in use; and
if said first target address is not in use, then the network device is provided with said first target address.

3. The method for linking an audiovisual capture device according to claim 2, wherein said first target address is in use, then said first target address is produced anew.

4. The method for linking an audiovisual capture device according to claim 1, wherein said second processing procedure comprises the following steps:
determining whether or not said terminal device is provided with said second target address;
if said terminal device is provided with said second target address, then said second target address is used to enable information linking between said terminal device and said audiovisual capture device; and
if said terminal device is not provided with said second target address, then enable said terminal device to be provided with said second target address.

5. The method for linking an audiovisual capture device according to claim 1, wherein said first processing procedure is automatically executed when said audiovisual capture device is activated.

6. The method for linking an audiovisual capture device according to claim 1, wherein said terminal device is either a host computer, a PDA or an electronic device provided with communication functionality and ability to enable operations to be carried out and settings to be made thereon.

7. The method for linking an audiovisual capture device according to claim 1, wherein said audiovisual capture device is either a network camera, a network audiovisual server or a network audiovisual storage device or a combination of the same.

8. An audiovisual capture device that automatically produces a first target address when activated, comprising:
a main program, which is used to execute initialization operations;
an address producing unit, which is used to produce said first target address;
an address search unit, which is used to search a network for the address of at least one hardware device;
a broadcasting unit, which is used to broadcast at least one probing packet;
an arbiter unit, which is used to differentiate the reply results of said probing packets;
an address allocation unit, which is used to allocate said first target address after confirmation; and
an announcement unit, which is used to announce said first target address after confirmation.

9. The audiovisual capture device that automatically produces a first target address when activated according to claim 8, wherein said audiovisual capture device is either a network camera, a network audiovisual server or a network audiovisual storage device or a combination of the same.
